(19) United States
(12) Patent Application Publication
(10) Pub. No.: US 2004/0178190 A1
(43) Pub. Date: Sep. 16, 2004

(54) Non-uniform wattage density heater

(76) Inventors: Brad Bivens, Ashville, OH (US); Michael J. Neal, Columbus, OH (US); Doug Dietz, Columbus, OH (US)

Correspondence Address: Porter, Wright, Morris & Arthur, LLP, 41 South High Street, Columbus, OH, 43215, US

(21) Appl. No.: 10/733,748

(22) Filed: Dec. 11, 2003

Related U.S. Application Data
(60) Provisional application No. 60/432,630, filed on Dec. 11, 2002.

(51) Int. Cl. H05B 3/34

(52) U.S. Cl. 219/549

(57) ABSTRACT

A heater assembly includes first and second flexible layers and first, second, third, and fourth flexible electrical resistance heating elements connected in series and positioned between the first and second flexible layers. The first, second, third and fourth heating elements form a plurality of heating zones having different watt densities so that heat is non-uniformly produced by the heating zones. In a preferred embodiment, the first, second, third, and fourth heating zones are concentric circles and the outer most first heating zone has a watt density higher than the inner most fourth heating zone.

### CROSS-REFERENCE TO RELATED APPLICATIONS

This application claims priority benefit of U.S. Provisional Patent Application No. 60/432,630, filed on Dec. 11, 2002, the disclosure of which is expressly incorporated herein in its entirety by reference.

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to electrical resistance heater assemblies and, more particularly, to flexible or semi-flexible heater assemblies such as heating pads, jackets, and blankets.

### BACKGROUND OF THE INVENTION

In many industries, it is advantageous to heat objects in a desired manner. Often, an electrical resistance heater assembly or heater such as a heating pad, jacket, or blanket is disposed on or about a surface of the object to be heated so that, when activated, the heater elevates the temperature of the object, a portion of the object, and/or contents of the object. For example see U.S. Pat. No. 5,883,364, the disclosure of which is expressly incorporated herein in its entirety by reference. These heaters are often flexible or semi-flexible to substantially conform to the surface to be heated and provide uniform heat to the surface to be heated.

While these heaters may adequately provide heat to the surface being heated, in some applications they do not obtain a uniform temperature across the surface being heated. A uniform temperature across the surface being heated in some instances is not obtained because some portions of the surface have heat sinks or the like which lower the temperature of those portions. In some applications it is desired to have a uniform or substantially uniform temperature throughout the surface. For example, in a composite repair patch it is desired to obtain a substantially uniform temperature in order to get a proper cure of the materials. However, the fin effect of heat sinks on the patch often cause the temperature across the patch to be undesirably non-uniform. Accordingly, there is a need in the art for an improved heating apparatus.

### SUMMARY OF THE INVENTION

In accordance with one aspect of the present invention a heater assembly includes, in combination, first and second flexible layers, and at least one flexible electric heating element positioned between the first and second flexible layers and forming first and second heating zones. The at least one flexible electric heating element provides different watt densities in the first and second heating zones so that heat is non-uniformly produced by the heating zones.

In accordance with another aspect of the present invention, a heater assembly comprises, in combination, first and second flexible layers, and a plurality of flexible electrical resistance heating elements connected in series and positioned between the first and second flexible layers. The plurality heating elements form a plurality of heating zones having different watt densities so that heat is non-uniformly produced by the heating zones.

In accordance with yet another aspect of the present invention, a heater assembly comprises, in combination, first and second flexible layers, and first, second, third, and fourth flexible electrical resistance heating elements connected in series and positioned between the first and second flexible layers. The first, second, third and fourth heating elements form a plurality of heating zones having different watt densities so that heat is non-uniformly produced by the heating zones.

From the foregoing disclosure and the following more detailed description of various preferred embodiments it will be apparent to those skilled in the art that the present invention provides a significant advance in the technology of heater assemblies. Particularly significant in this regard is the potential the invention affords for providing a high quality, reliable, simple, and low cost assembly with improved operational performance. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a top plan view of a heater assembly including a flexible blanket according to the present invention, wherein vacuum port assemblies and an insulating cover assembly are removed for clarity;

FIG. 2 is an enlarged, fragmented cross-sectional view taken along line 2-2 of FIG. 1;

FIG. 3 is a top plan view similar to FIG. 1 but wherein an outer layer of the blanket of the heater assembly of FIGS. 1 and 2 is removed to show the flexible heating elements within the blanket;

FIG. 4 is a diagrammatic view similar to FIG. 3 but showing the heating elements of the heater assembly of FIGS. 1 to 3 in schematic form and lengths of sections of the heating elements;

FIG. 5 is a wiring diagram schematically showing the heating elements of the heater assembly of FIGS. 1 to 4;

FIG. 6 is an enlarged, exploded side elevational view of the vacuum port assembly of the heater assembly of FIGS. 1 to 5;

FIG. 7 is a bottom plan view of the insulating cover assembly of the heater assembly of FIGS. 1 to 6;

FIG. 8 is an enlarged, fragmented cross-sectional view similar to FIG. 2 but showing an alternative embodiment of the heater assembly of FIGS. 1 to 7;

FIG. 9 is an enlarged, fragmented cross-sectional view similar to FIGS. 2 and 8 but showing another alternative embodiment of the heater assembly of FIGS. 1 to 7.

It should be understood that the appended drawings are not necessarily to scale, presenting a somewhat simplified representation of various preferred features illustrative of the basic principles of the invention. The specific design features of the heater assembly as disclosed herein, including, for example, specific dimensions, orientations, and shapes of the various components will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the heater assembly illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved heater assemblies disclosed herein. The following detailed discussion of various alternative and preferred embodiments will illustrate the general principles of the invention with reference to a flexible heating blanket for applications in industrial environments such as, for example, composite patch repair. Other embodiments suitable for other applications will be apparent to those skilled in the art given the benefit of this disclosure.

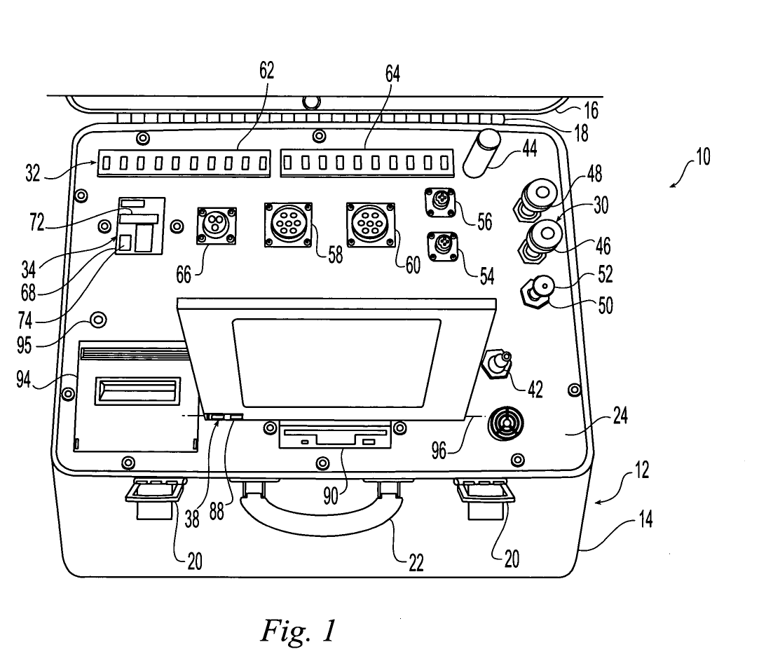

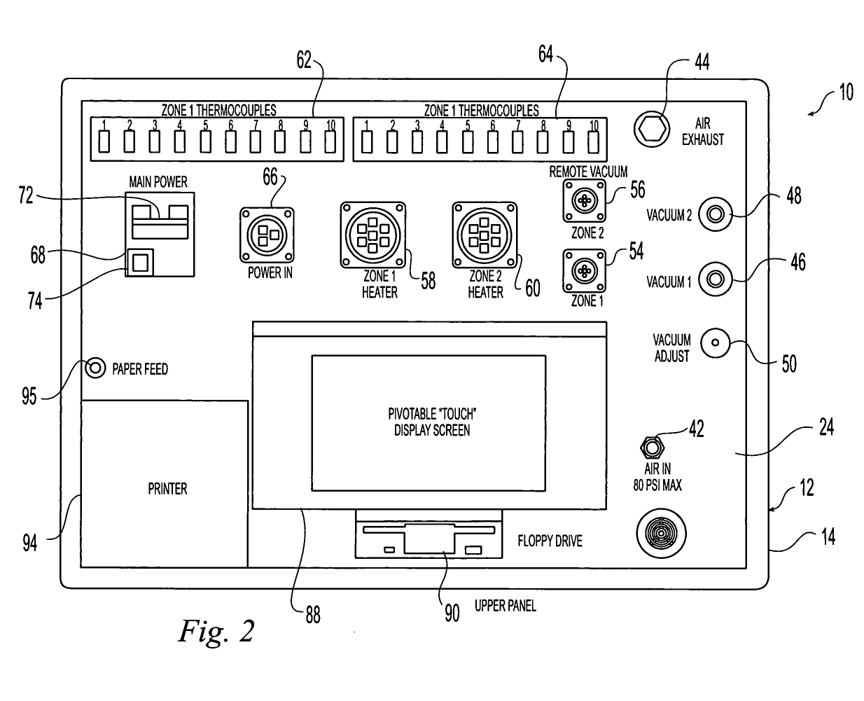

Referring now to the drawings, FIGS. 1 and 2 illustrate a heater assembly 10 according to the present invention which can disposed about or on a surface 12 to be heated. The illustrated heater assembly 10 includes a flexible first, lower or inner layer or liner 14, a flexible second, upper or outer layer or liner 16 located above the inner layer, at least one electrical resistance heating element 18 located between the inner and outer layers 14, 16, a vacuum seal 20 for sealing securing the inner layer 14 to the surface 12 to pull a vacuum in a cavity 22 formed between the surface 12 and the inner layer 14, a pair of vacuum port assemblies 24 for connecting the cavity 22 to a vacuum source, and a insulating cover assembly 26 removably secured to the outer layer 16 and covering the outer layer 16 for reducing the escape of heat from the heater assembly 10 through the outer layer 16.

The illustrated inner layer 14 is generally planer having a circular outer edge. While the illustrated inner layer 14 is circular, the inner layer 14 can have any suitable shape, such as, for example, oval, triangular, square, or rectangular. The inner layer 14 is sized to cover the surface 12 to be heated. The illustrated inner layer 14 has a diameter of about sixteen inches but any other suitable size can be utilized depending on the use application of the heater assembly 10. The illustrated inner layer 14 is provided with a pair of openings 28 therethrough which are located near the outer edge on opposite sides of the inner layer 14. It is noted that a greater or lesser number of openings 28 can be provided depending on the number of vacuum port assemblies 24 being utilized as described in more detail hereinafter. The bottom or outer surface of the illustrated inner layer 14 is generally flat or planar to substantially directly contact the surface 12 of the object to be heated but it is noted that the bottom surface can alternatively be provided with a texture or protrusions to allow air flow between the heater assembly 10 and the surface 12 of the object to be heated. The illustrated inner layer 14 is formed of a flexible material but alternatively can be a semi-flexible, semi-rigid, or rigid material depending on the application of the heater assembly 10. The illustrated inner layer 14 is also formed of a high temperature material but can alternatively comprise other materials depending on the thermal output of the heating elements 18. The illustrated inner layer 14 comprises silicone rubber but alternatively can be any suitable material such as for example, fiberglass, rubber, plastic, cloth or the like. A suitable silicone rubber is RTV manufactured by GE plastics.

The outer layer 16 is preferably sized and shaped to cooperate with the inner layer 14. The illustrated outer layer 16 is generally planer having a circular outer edge. While the illustrated outer layer 16 is circular, the outer layer 16 can have any suitable shape, such as, for example, oval, triangular, square, or rectangular. The outer layer 16 is sized to cover the inner layer 14 with the heating elements 18 located therebetween. The illustrated outer layer 16 has a diameter of about sixteen inches but any other suitable size can be utilized depending on the use application of the heater assembly 10. The illustrated outer layer 16 is provided with a pair of openings 30 therethrough which are located near the outer edge on opposite sides of the outer layer 16. The openings 30 are sized and located to cooperate with the openings 28 in the inner layer 14. It is noted that a greater or lesser number of openings 30 can be provided depending on the number of vacuum port assemblies 24 being utilized as described in more detail hereinafter. The illustrated outer layer 16 is formed of a flexible material but alternatively can be a semi-flexible, semi-rigid, or rigid material depending on the application of the heater assembly 10. The illustrated outer layer 16 is also formed of a high temperature material but can alternatively comprise other materials depending on the thermal output of the heating elements 18. The illustrated outer layer 16 comprises silicone rubber cloth but alternatively can be any suitable material such as for example, fiberglass, rubber, plastic or the like. A suitable silicone rubber cloth is a high-temperature fabric impregnated with RTV manufactured by GE plastics.

The illustrated at least one heating element 18 is located between and directly contacting the inner and outer layers 14, 16. The illustrated heating element 18 is located directly adjacent the inner layer 14 so that only the inner layer 14 separates the heating element 18 from the surface 12 to be heated when the inner layer 14 is placed near the surface 12 to be heated and a vacuum is pulled in the cavity 22 as described hereinafter.

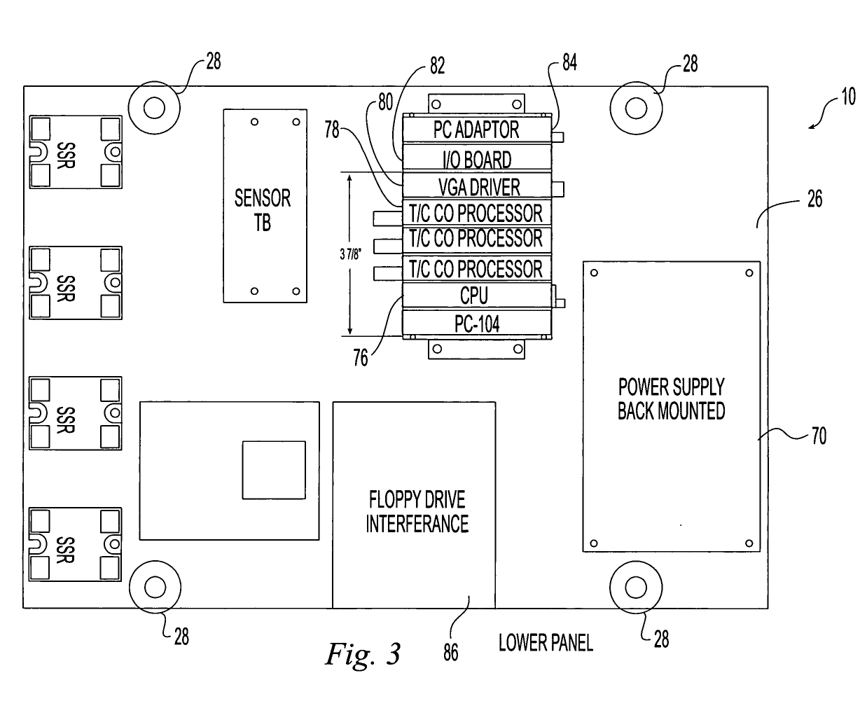

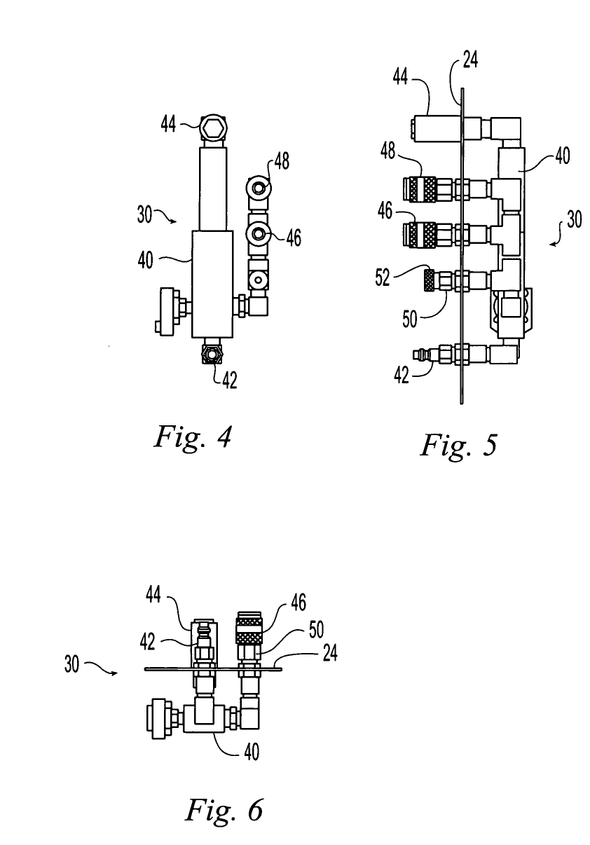

As best shown in FIGS. 3 to 5, the illustrated heater assembly 10 includes four heating elements or tapes A, B, C, D which form four separate, heating zones or sections 32, 34, 36, 38 respectively. It is noted that a greater or lesser number of heating zones 32, 34, 36, 38 can utilized such as, for example, two, three, five, six or more depending on the use application of the heater assembly 10. The illustrated heating zones 32, 34, 36, 38 are in the shape of concentric circles or rings but other suitable shapes, orientations, and locations can be utilized depending on the use application of the heater assembly 10. The illustrated first zone 32 has a diameter of about 11 inches and an area of about 33 square inches. The illustrated second zone 34 has a diameter of about 9 inches and an area of about 34 square inches. The illustrated third zone 36 has a diameter of about 6 inches and an area of about 22 square inches. The illustrated fourth zone diameter of about 2.5 inches and an area of about 5 square inches. It is noted that each of the zones 32, 34, 36, 38 can be larger or smaller depending on the use application of the heater assembly 10.

Each illustrated tape A, B, C, D is constructed of bundled resistance wires which are knitted into a desired form. The resistance wires are preferably multi-strand grounded resistance wires. It is noted, however, that other suitable types of flexible heating elements 18 can be utilized within the scope of the present invention such as, for example, etched foil heating elements, polymer encapsulated heating elements, resistance films, laminated resistance heaters, or the like. See for example, U.S. Pat. Nos. 6,519,835, 5,883,364, 5,586,214, 5,521,357, 3,878,362, 3,268,846, 2,889,439, 2,710,909, the disclosures of which are expressly incorporated herein in their entireties by reference.

As best shown in FIG. 3, the illustrated tapes A, B, C, D are shaped in a serpentine manner to form the concentric rings. The illustrated first or outermost tape A includes two concentric circular portions having lengths of about 36.375 inches and about 32.875 inches respectively and forms the first zone 32. The illustrated second tape B includes four concentric circular portions having lengths of about 29.75, about 27.00, about 24.25, and about 21.50 inches respectively and forms the second zone 34. The illustrated third tape C includes three concentric circular portions having lengths of about 18.375, about 14.75, and about 11.25 inches respectively and forms the third zone 36. The illustrated fourth or innermost tape D includes two concentric circular portions having lengths of about 8.125, and about 5.375 inches respectively and forms the fourth zone 38. The illustrated tapes A, B, C, D form eleven rings as well as additional length at the center. It is noted that each of the tapes A, B, C, D can alternatively have a lesser or greater number of circular portions and each of the circular portions can alternatively have lesser or greater lengths depending on the use application of the heater assembly 10.

Preferably, insulated bridge connectors 40 electrically interconnect the tapes A, B, C, D together in series. Preferably, first and second lead wires 42, 44 are connected to the first and fourth tapes A, D respectively and extend radially outward to the edge of the heater assembly 10 to a suitable electrical plug 46 for connection to a suitable electrical power source 48. The illustrated first and second leads 42, 44 are provide with a conduit or covering 50 extending from the plug 46 to a location just within the outer edge of the inner and outer layers 14, 16. The illustrated covering 50 is a silicone rubber tube but alternatively any other suitable material can be utilized.

The heating elements A, B, C, D collectively have a non-uniform watt density (watts/in²), that is different watt densities in the different zones 32, 34, 36, 38, so that different amounts of heat are produced in the different zones 32, 34, 36, 38. The illustrated heating elements A, B, C, D have different resistances densities (ohm/in²)to produce the non-uniform watt density (watts/in²). It is noted that the resistance density (ohm/in²)can be varied by changing the resistance of the tape (ohms/ft), the length of the tape (ft) and/or the area (in2) to which the tape is applied. In the illustrated embodiment, all three of these variables are altered between the zones 32, 34, 36, 38. The illustrated first tape A has a resistance of about 1.269 ohms per foot to produce a total resistance of about 7.3 ohms. The illustrated second tape B has a resistance of about 0.951 ohms per foot to produce a total resistance of about 8.1 ohms. The illustrated third tape C has a resistance of about 1.045 ohms per foot to produce a total resistance of about 3.9 ohms. The illustrated fourth tape D has a resistance of about 0.595 ohms per foot to produce a total resistance of about 0.85 ohms. Thus, the illustrated heating elements A, B, C, D produce watt densities of about 0.223 ohms per square inch for the first zone 32, about 0.23 ohms per square inch for the second zone 34, about 0.175 ohms per square inch for the third zone 36, and about 0.119 ohms per square inch for the fourth zone 38. In this manner, the zones 32, 34, 36, 38 are provided with an increasingly higher watt density as you travel outward from the center of the heater assembly 10. The ohm density, and thus the watt density, changes in a decreasing manner as you move from the outer most zone 32 to the inner most zone 38 at the center of the heater assembly 10. It is noted that the watt density can alternatively be made to vary in any other desired pattern depending on the use application of the heater assembly 10 such as, for example, the inner most zone have a higher watt density than the outer most zone 32 or the watt density can step up or down at only one zone, all of the zones, or any number of the zones 32, 34, 36, 38. It is noted that other suitable ways for producing a non-uniform watt density can be alternatively utilized such as, for example, by more densely packing the tapes A, B, C, D in some zones 32, 34, 36, 38 more than others. It is further noted that the tapes A, B, C, D can also formed alternative patterns other than concentric circles so that other desired watt density patterns can be obtained such as, for example, a stripe pattern could provide one half with a higher density than the other half.

Once assembled together, the inner and outer layers 14, 16 and the heating elements A, B, C, D form a flexible blanket 52. The blanket 52 is preferably formed by laying the heating elements A, B, C, D and the lead wires 42, 44 on the top surface of the inner layer 14 in their desired locations. The various wires A, B, C, D, 40, 42, 44 can be secured to the inner layer 14 in any desired manner such as, for example, bonding with silicone rubber so that the wires A, B, C, D, 40, 42, 44 are maintained in their desired positions. The covering 50 is placed on the lead wires 42, 44. The outer layer 16 is then positioned over the inner layer 14 with the heating elements A, B, C, D therebetween and the covering 50 partially extending therebetween. The blanket 52 is then preferably cured under temperature and pressure so that the outer layer 16 and the inner layer 14 are secured together. Preferably, the inner and outer layers 14, 16 become unitary near their outer edges. It is noted that the layers 14, 16 can alternatively be secured together in other manners and/or additional layers can be included in the blanket 52.

As best shown in FIGS. 1 and 2, the vacuum seal 20 includes a seal member 53 downwardly extending from the bottom surface of the inner layer 14 for sealing securing the inner layer 14 to the surface 12 to be heated. The illustrated seal member 53 is circular shaped and extends the circumference of the inner layer 14 slightly inward of the outer edge of the inner layer 14. The seal member 53 can be secured to the inner layer 14 in any suitable manner such as, for example, bonded with silicone rubber. The seal member 53 can be of any suitable type which enables at least an air tight seal or near air-tight seal so that a vacuum source connected to the vacuum port assemblies 24 can pull a vacuum in the cavity 22 formed between the surface 12 to be and the inner layer 14.

As best shown in FIGS. 2 and 6, each illustrated vacuum port assembly 24 includes a two-part coupler 54, a washer 56, and a vacuum fitting 58. The coupler 54 has a first or upper portion 54A having a air passage 60 therethrough. The upper portion 54A is sized to closely extend through the openings 28, 30 in the inner and outer layers 14, 16 of the blanket 52. The coupler 54 also has a lower portion 54B with a threaded stem which cooperates with a thread in the passage 60 to connect the lower portion 54B with the upper portion 54A with the blanket 52 therebetween to seal the openings 28, 30. The washer 56 is preferably located between the upper portion 54A and the blanket 52. The illustrated vacuum fitting 58 has a threaded stem which cooperates with a thread of the passage 60 to secure the vacuum fitting 58 to the upper end of the coupler upper portion 54A. The vacuum fitting 58 is adapted so that an air conduit or hose can be connected thereto to connect a vacuum source to the passage 60. During operation, the vacuum source pulls air from the cavity 22 through the passage 60 in the coupler 54 so that the bottom surface of the inner layer 14 is pulled closely to the surface 12 to be heated and substantially without an air gap therebetween. While the illustrated heater assembly 10 is provided with a pair of vacuum port assemblies 24, it is noted that alternatively a fewer or greater number of vacuum port assemblies 24 can be provided. It is also noted that the vacuum port assemblies 24 can alternatively be eliminated in use applications where a vacuum is not desired. It is further noted that the vacuum port assemblies 24 can alternatively take any other suitable form.

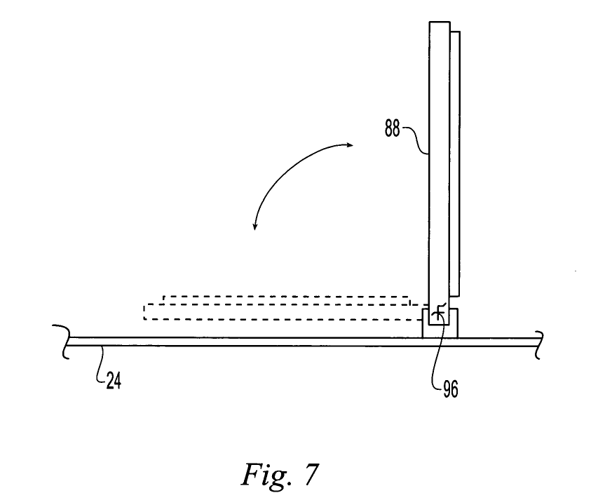

As best shown in FIGS. 1, 2 and 7, the insulating cover assembly 26 is removably secured to the outer layer 16 of the blanket 52 and covering the outer layer 16 for reducing the escape of heat from of heater assembly 10 through the outer layer 16. The insulating cover assembly 26 can reduce the power needed to heat the surface 12 to be heated. By removably, securing the insulating cover assembly 26, it can be easily removed and replaced. The illustrated insulating cover assembly 26 includes an insulation layer 62 and a removable fastener 64 securing the insulation layer 62 to the outer layer 16 of the blanket 52.

The insulation layer 62 is preferably sized and shaped to cooperate with the outer layer 16 of the blanket 52. The illustrated insulation layer 62 is generally planer having a circular outer edge. While the illustrated insulation layer 62 is circular, the insulation layer 62 can have any suitable shape, such as, for example, oval, triangular, square, or rectangular. The illustrated insulation layer 62 is sized to entirely cover the outer layer 16 of the blanket 52. The illustrated insulation layer 62 has a diameter of about sixteen inches but any other suitable size can be utilized depending on the use application of the heater assembly 10. The illustrated insulation layer 62 is provided with a pair of openings 66 therethrough which are located near the outer edge on opposite sides of the insulation layer 62. The openings 66 are sized and located to cooperate with the vacuum port assemblies 24. It is noted that a greater or lesser number of openings 66 can be provided depending on the number of vacuum port assemblies 24 being utilized as described in more detail hereinafter. Each opening 66 is provided with a slit 68 extending from the opening 66 to the outer edge of the insulation layer 62 so that the vacuum port assemblies 24 can be inserted into the openings 66 through the slits 68. The illustrated insulation layer 62 is formed of a flexible material but alternatively can be a semi-flexible, semi-rigid, or rigid material depending on the application of the heater assembly 10. The illustrated insulation layer 62 is also formed of a high temperature material but can alternatively comprise other materials depending on the thermal output of the heating elements 18. The illustrated insulation layer 62 comprises foamed silicone rubber but alternatively can be any suitable material such as for example, fiberglass, rubber, plastic or the like. A suitable foamed silicone rubber is a foamed RTV manufactured by GE plastics.

The illustrated removable fastener 64 is a hook and loop type fastener such as, for example, VELCRO. In the illustrated embodiment, high temperature loop material 64A is secured to the top surface of the outer layer 16 and cooperating high temperature hook material 64B is secured to the bottom surface of the insulation layer 62. The hook and loop material 64A, 64B can be provided in any suitable quantity and pattern to removably secure the insulation layer 62 above the outer layer 16 of the blanket 52. The hook and loop material 64A, 64B can be secured to the layers 16, 62 in any suitable manner such as, for example, bonded with silicone rubber. It is noted that any other suitable type of removable fastener or permanent fastener, such as bonding or sewing, can alternatively be utilized to secure the insulation layer 62 above the outer layer 16 of the blanket 52.

For use, the heater assembly 10 is placed onto the surface 12 to be heated with the inner layer 14 directly contacting the surface 12 to be heated. The vacuum source is activated to withdraw air from the cavity 22 formed between the inner layer 14 and the surface 12 to be heated. The vacuum pulls the inner layer 14 tight against the surface 12 and substantially removes any air gap located therebetween. The heater assembly 10 can alternatively be secured on the surface 12 in any desired manner such as, for example, pressure sensitive adhesive, mechanical fasteners, mechanical clamping devices, adhesive tape, or a thin layer of a silicone rubber like RTV. Once installed, the power source 48 is activated to supply voltage to the heating elements A, B, C, D via the lead wires 42, 44 to produce heat due to the electrical resistance of the heating elements A, B, C, D. The heat produced by the heating elements A, B, C, D transfers from the heating elements A, B, C, D to the surface 12 to be heated through the inner layer 14. Because different amounts of heat are provided in the different zones 32, 34, 36, 38, a desired temperature profile is provided on the surface 12 such a constant temperature profile. If desired, a thermostat and/or temperature controller can regulate the temperature of the heating elements to provide feed back control to obtain the desired temperature profile.

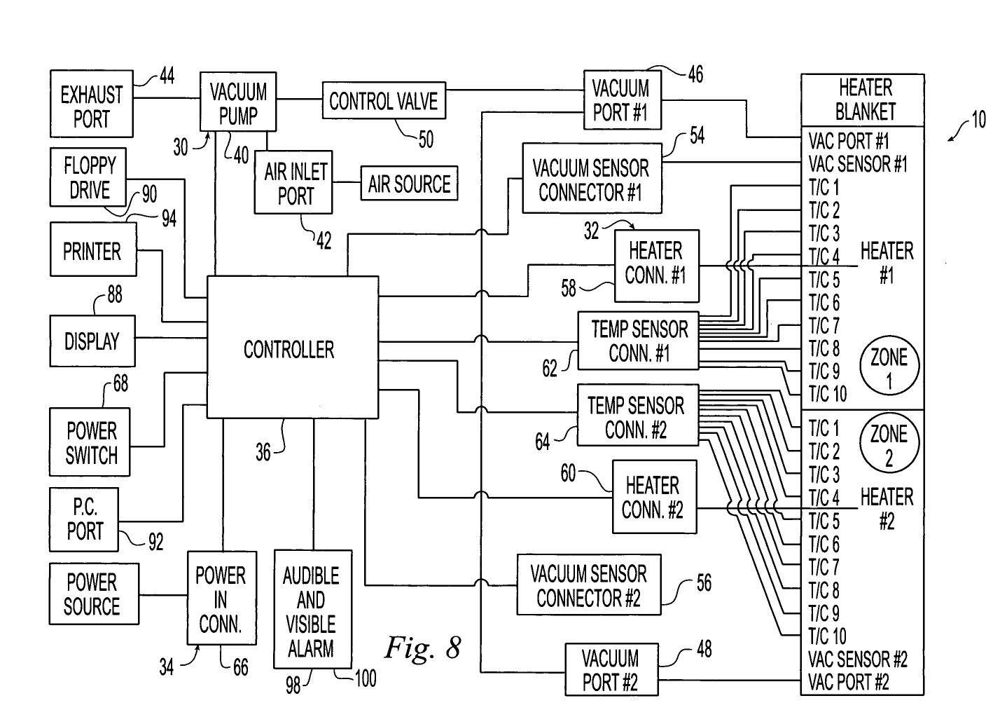

FIG. 8 illustrates a heater assembly 100 according to a second embodiment of the present invention wherein like reference numbers are used to indicate like structure. The heater assembly 100 according to the second embodiment is substantially the same as the heater assembly 10 according the first embodiment of the present invention disclosed in detail hereinabove except that no insulation layer is utilized. This embodiment illustrates that the insulation layer can be eliminated if desired.

FIG. 9 illustrates a heater assembly 200 according to a third embodiment of the present invention wherein like reference numbers are used to indicate like structure. The heater assembly 200 according to the third embodiment is substantially the same as the heater assembly 10 according the first embodiment of the present invention disclosed in detail hereinabove except that that the inner and outer layers 14, 16, 18 are comprised of different material and the insulation layer 62 is provided within the blanket 52 between the heating elements 18 and the outer layer 16. This embodiment illustrates that the inner and outer layers 14, 16 can comprise different materials, the insulation layer 62 can be located in different location, and the blanket 52 can comprise additional layers.

The illustrated inner and outer layers 14, 16 comprise a high-temperature, man-made, multi-filament sheet structure, that is, cloth or fabric. The cloth or fabric can be formed of any high-temperature material which is suitable for the temperature range of the application such as, for example, fiberglass cloth or NOMEX cloth. A suitable fiberglass cloth is available from Alpha Associates, Inc. of Palantine, Ill. NOMEX cloth is a product of E.I. Du Pont de Nemours and Company of Wilmington, Del.

The illustrated insulation layer 62 is located between the outer layer 16 and the heating elements 18 within the blanket 52. The illustrated insulation layer 62 is formed of a high temperature fiberglass material but can alternatively comprise other materials depending on the thermal output of the heating elements 18. A suitable insulative material is fiberglass insulation such as, for example, Insulbatte/Tempmat available from Great Lakes Textiles, Inc. of Walton Hills, Ohio.

It is noted that each of the various features of the illustrated preferred embodiments can be utilized with any of the other embodiments in any combination. For example, the third embodiment could utilize the insulting cover assembly of the first embodiment instead of or in addition to the internal insulation layer.

From the foregoing disclosure and detailed description of certain preferred embodiments, it will be apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A heater assembly comprising, in combination:
first and second flexible layers;
at least one flexible electric heating element positioned between the first and second flexible layers and forming first and second heating zones; and
wherein the at least one flexible electric heating element provides different watt densities in the first and second heating zones so that heat is non-uniformly produced by the heating zones.

2. The heater assembly according to claim 1, wherein the at least one electric heating element is an electrical resistance heating element.

3. The heater assembly according to claim 2, wherein the electrical resistance heating element comprises bundled resistance wires knitted into a desired form.

4. The heater assembly according to claim 1, wherein the first and second heating zones are concentric circles.

5. The heater assembly according to claim 1, wherein the first heating zone is located radially outward of the second heating zone and has a first watt density higher than a second watt density of the second heating zone.

6. The heater assembly according to claim 1, wherein the at least one flexible electric heating element includes a first electric heating element forming the first heating zone and a second electric heating element forming the second heating zone.

7. The heater assembly according to claim 6, wherein the first electric heating element is connected in series with the second electric heating element.

8. The heater assembly according to claim 6, wherein the first and second electric heating elements have different resistance per unit length.

9. The heater assembly according to claim 1, wherein the at least one flexible electric heating element forms a third heating zone with a different watt density than the first and second heating zones.

10. The heater assembly according to claim 1, wherein the at least one flexible electric heating element forms a fourth heating zone with a different watt density than the first, second, and third heating zones.

11. The heater assembly according to claim 1, wherein the first and second layers comprise silicone rubber.

12. The heater assembly according to claim 1, further comprising an insulation layer positioned adjacent the second layer to reduce heat passing through the second layer.

13. The heater assembly according to claim 12, wherein the insulation layer is secured to an outer surface of the second layer.

14. The heater assembly according to claim 12, wherein the insulation layer is secured to an outer surface of the second layer with a removable fastener.

15. The heater assembly according to claim 12, wherein the insulation layer comprise silicone rubber.

16. The heater assembly according to claim 1, further comprising a vacuum seal member secured to a bottom surface of the first layer and at least one vacuum port extending through the first layer.

17. A heater assembly comprising, in combination:
first and second flexible layers;
a plurality of flexible electrical resistance heating elements connected in series and positioned between the first and second flexible layers; and
wherein the plurality heating elements form a plurality of heating zones having different watt densities so that heat is non-uniformly produced by the heating zones.

18. A heater assembly comprising, in combination:
first and second flexible layers;
first, second, third, and fourth flexible electrical resistance heating elements connected in series and positioned between the first and second flexible layers; and
wherein the first, second, third and fourth heating elements form a plurality of heating zones having different watt densities so that heat is non-uniformly produced by the heating zones.

19. The heater assembly according to claim 18, wherein the first, second, third, and fourth heating zones are concentric circles.

20. The heater assembly according to claim 1, wherein the first heating zone is located radially outward of the second heating zone, the second heating zone is located radially outward of the third heating zone, and the first heating zone has a watt density higher than the fourth heating zone.
